(19) United States
(12) Patent Application Publication
(10) Pub. No.: US 2008/0024552 A1
(43) Pub. Date: Jan. 31, 2008

(54) METHODS AND APPARATUS FOR IMPROVED MANUFACTURING OF COLOR FILTERS

(76) Inventors: John M. WHITE, Hayward, CA (US); Quanyuan SHANG, Saratoga, CA (US)

Correspondence Address: DUGAN & DUGAN, PC, 245 Saw Mill River Road, Suite 309, Hawthorne, NY, 10532, US

(21) Appl. No.: 11/829,494

(22) Filed: Jul. 27, 2007

Related U.S. Application Data
(60) Provisional application No. 60/820,746, filed on Jul. 28, 2006.

(51) Int. Cl. B41J 2/145

(52) U.S. Cl. 347/41

(57) ABSTRACT

Methods and apparatus are provided in which a substrate is aligned so that a longitudinal dimension of a plurality of sub-pixel wells formed on the substrate are substantially perpendicular to a printing direction. Ink is deposited in a subset of the sub-pixel wells via nozzles of a print head wherein each of a plurality of the nozzles deposits a plurality of ink drops in each of the subset of the sub-pixel wells. Numerous other aspects are disclosed.

### CROSS REFERENCE TO RELATED APPLICATIONS

The present application claims priority to U.S. Provisional Patent Application Ser. No. 60/820,746 filed Jul. 28, 2006, and entitled “Methods And Apparatus For Improved Manufacturing Of Color Filters” (Attorney Docket No. 11232/L) which is hereby incorporated herein by reference in its entirety for all purposes.

The present application is also related to the following commonly-assigned, co-pending U.S. patent applications, which are hereby incorporated herein by reference in their entirety for all purposes:

U.S. patent application Ser. No. 11/061,120, filed Feb. 18, 2005 and entitled “Methods And Apparatus For Precision Control Of Print Head Assemblies” (Attorney Docket No. 9769);

U.S. patent application Ser. No. 11/238,632, filed Sep. 29, 2005 and entitled “Methods And Apparatus For Inkjet Printing Color Filters For Displays” (Attorney Docket No. 9521-5/P01);

U.S. Provisional Patent Application Ser. No. 60/771,284, filed Feb. 7, 2006 and entitled “Methods And Apparatus For Reducing Irregularities In Color Filters” (Attorney Docket No. 10899); and

U.S. Provisional Patent Application Ser. No. 60/625,550, filed Nov. 4, 2004 and entitled “Apparatus And Methods For Forming Color Filters In A Flat Panel Display By Using Inkjetting.”

### FIELD OF THE INVENTION

The present invention relates generally to electronic device fabrication methods, and is more particularly concerned with the manufacture of color filters for flat panel displays.

### BACKGROUND OF THE INVENTION

The flat panel display industry has been attempting to employ inkjet printing to manufacture display devices, in particular, color filters. One problem with effective employment of inkjet printing is that it is difficult to inkjet ink or other material accurately and precisely on a substrate while having high throughput. Accordingly, there is a need for improved methods and apparatus for using inkjet heads to efficiently print on a substrate.

### SUMMARY OF THE INVENTION

In an aspect of the invention, a method is provided in which a substrate is aligned so that a longitudinal dimension of a plurality of sub-pixel wells formed on the substrate are substantially perpendicular to a printing direction; and ink is deposited in a subset of the sub-pixel wells via nozzles of a print head wherein each of a plurality of the nozzles deposits a plurality of ink drops in each of the subset of the sub-pixel wells.

In another aspect of the invention, an apparatus is provided that includes a stage adapted to align a substrate; and a print head including a plurality of nozzles and being adapted to deposit ink drops into pixel wells on the substrate. The apparatus is operative to align the substrate on the stage so that a longitudinal dimension of a plurality of sub-pixel wells formed on the substrate are substantially perpendicular to a printing direction; and deposit ink in a subset of the sub-pixel wells via the nozzles wherein each of the nozzles deposits a plurality of ink drops in each of the subset of the sub-pixel wells.

In yet another aspect of the invention, a system is provided that includes a stage adapted to align a substrate; a print bridge spanning across the stage; a plurality of print heads supported by the print bridge, each print head including a plurality of nozzles and being adapted to deposit ink drops into pixel wells on the substrate. The system is operative to align the substrate on the stage so that a longitudinal dimension of a plurality of sub-pixel wells formed on the substrate are substantially perpendicular to a printing direction; and deposit ink in a subset of the sub-pixel wells via the nozzles wherein each of the nozzles deposits a plurality of ink drops in each of the subset of the sub-pixel wells.

Other features and aspects of the present invention will become more fully apparent from the following detailed description of exemplary embodiments, the appended claims and the accompanying drawings.

### BRIEF DESCRIPTION OF THE DRAWINGS

FIG. 1 is a magnified representation of an example of a portion of an ideal color filter.

FIG. 2 is a magnified representation of an example of a plan view of a portion of color filter with arrows indicating mura irregularities.

FIG. 3 is an example representation of the output of a flat panel display exhibiting mura irregularities.

FIG. 4 is a perspective view representation of portions of two columns of pixels with a mura irregularity.

FIG. 5 is a perspective view of an inkjet printing system according to some embodiments of the present invention.

FIG. 6 is a schematic semi-transparent close-up view of a print head over a portion of a substrate during printing according to some embodiments of the present invention.

FIG. 7 is a schematic semi-transparent close-up view of a print head over a portion of a substrate during printing according to some embodiments of the present invention.

FIG. 8 is a flowchart depicting an example method according to some embodiments of the present invention.

### DETAILED DESCRIPTION

The present invention provides systems and methods for improving throughput of inkjet printing systems while simultaneously eliminating an error condition called mura that may otherwise occur in the manufacture of color filters for flat panel displays. The present invention uses a combination of horizontal and vertical printing methods to improve throughput and avoid mura irregularities. Vertical printing refers to a conventional printing method wherein a single column of ink drops are deposited into a sub-pixel well (typically along a longitudinal axis of the sub-pixel well) by a single nozzle on an inkjet print head as the nozzle traverses the length of the sub-pixel well. For example, a single nozzle on a print head may sequentially deposit twenty drops into a sub-pixel well. In contrast, horizontal printing refers to a novel printing method wherein multiple nozzles each deposit a single ink drop into a sub-pixel well as the multiple nozzles traverse the short dimension (e.g., the width) of the sub-pixel well. For example, twenty nozzles on a print head may each concurrently (or nearly concurrently) deposit one drop into a sub-pixel well. In further contrast, the combination of horizontal and vertical printing methods of the present invention involves multiple nozzles each depositing multiple ink drops into a sub-pixel well as the multiple nozzles traverse the short dimension (e.g., the width) of the sub-pixel well. For example, ten nozzles may each deposit one to three drops into a sub-pixel well.

A mura error condition results from a phenomena that may occur when vertical printing is used to precisely deposit ink, or other materials, onto a substrate to form a color filter. Due to mechanical and electrical accuracy limitations, the volume and positioning of ink drops jetted onto a substrate may be uniformly off from the ideal target size and/or location such that even though the printer depositing the ink is operating within tolerances, the cumulative effect of repeating the same small error for each drop becomes a visible irregularity to a naked human eye viewing a flat panel display with a color filter manufactured using an inkjet printer. In other words, even if ink drops are consistently deposited within tolerances such that only imperceptible variations from the ideal occur for each and every individual drop, a series of drops that are uniformly so disposed may collectively create a perceptible irregularity. As indicated, this error condition may be referred to as a mura irregularity or effect. Mura is a transliterated term from Japanese and has no apparent English equivalent.

The present invention provides methods and apparatus for efficiently printing color filters without creating mura irregularities in flat panel displays. In accordance with the present invention, the amount of variation that occurs in depositing ink drops on a substrate is intentionally increased over conventional methods so that repeated uniformity in drop position and/or size is avoided in adjacent drops and thus, in adjacent sub-pixels too. “Nozzle averaging” (e.g., the average performance/accuracy of multiple nozzles) is thus used to reduce the chance that consistent variations of individual nozzles become visible. This results in improved pixel to pixel uniformity. The increased amount of variation in drop position and/or size is achieved through the combination of horizontal and vertical printing methods which use multiple different nozzles to each deposit multiple drops in each sub-pixel well as described above. The present invention further improves throughput by allowing more sub-pixels to be filled per print pass compared to other methods (e.g., vertical or horizontal printing methods) and by allowing the use of inkjet print heads that have more nozzles. In other words, the present invention allows more ink to be accurately deposited in less time without creating mura irregularities.

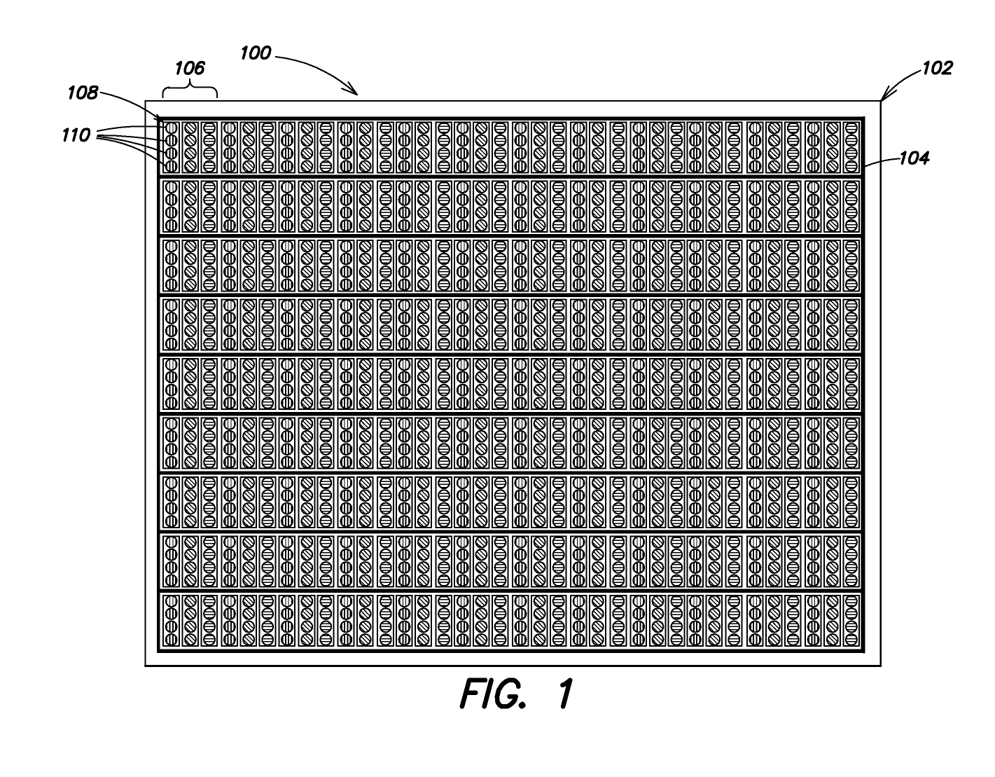

Turning to FIG. 1, a magnified representation of an example of an ideal color filter 100 is depicted. The color filter 100 includes a substrate 102 with an array of pixel wells defined by black matrix material 104. Each pixel 106 includes three different color (e.g., red, green, blue) sub-pixel wells 108 that are each filled with a series of ink drops 110. In the example shown, four drops of ink 110 have been deposited in a column in each sub-pixel well 108. During manufacture, the substrate 102 was moved on a stage, driven by an X-Y table, below a print head (not shown) disposed above the substrate 102. The print head deposited four drops of ink in each sub-pixel well 108.

The color filter 100 depicted in FIG. 1 is a representation of a plan view of an ideal color filter wherein each sub-pixel 108 includes drops 110 of an identical size that have been deposited exactly in the center of each of the sub-pixel wells 108. Ideal sizing and placement of ink drops can be difficult to achieve, particularly at high throughput rates. Various factors including electrical cross-talk between the signals used to trigger individual print head nozzles to jet ink can cause drop size variations. Among other things, mechanical error in the alignment of print head nozzles as well as the X-Y table may contribute to positioning error. While these types of errors may be corrected to a large extent, it may be difficult and/or cost prohibitive, for example, to adjust a fire pulse voltage signal for each nozzle (which controls drop size) to have less than a threshold percentage error tolerance or to improve the drop landing accuracy to less than +/− a threshold distance. As an example, inkjet printers may be able to control fire pulse voltage to within a 1% tolerance which may result in a +/−10% volume error and drop landing accuracy to within +/−5 um. While these accuracy thresholds or tolerances may consistently land properly sized drops within target sub-pixel wells, these tolerances may not be sufficient to avoid creating a mura irregularity.

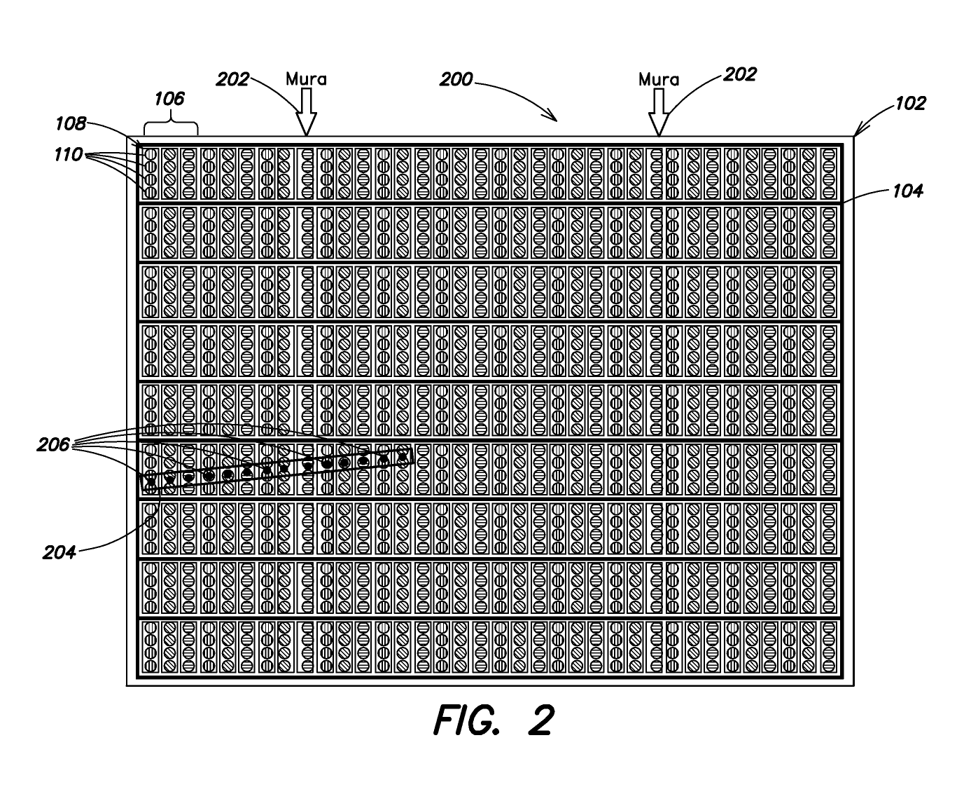

Turning to FIG. 2, a magnified representation of an example of a plan view of color filter 200 with arrows indicating locations of mura irregularities 202 is depicted. Note that the drops 110 are all positioned and sized to fit within their respective sub-pixel wells 106, in other words, within tolerances. Despite being within tolerance, mura irregularities occur where each drop within a column of sub-pixels is consistently displaced slightly off center within its respective sub-pixel well.

In the example shown, four drops of ink 110 have been deposited in a column in each sub-pixel well 108 using the conventional vertical printing method. During manufacture, the substrate 102 was moved on a stage, driven by an X-Y table, below a print head 204 disposed above the substrate 102. Every third nozzle 206 of the print head 204 deposited four drops of ink 110 in each sub-pixel well 108. The other sub-pixel wells were filled by other print heads (not shown). Note that the longitudinal axis of the sub-pixel wells 108 is substantially parallel to the print direction Y.

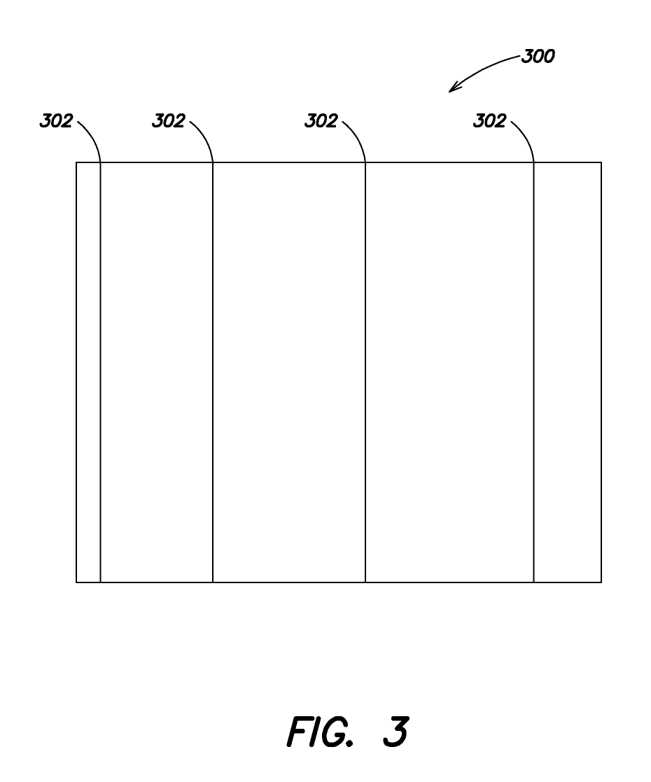

FIG. 3 depicts an example representation of the output of a flat panel display 300 exhibiting mura irregularities 302 while displaying a field of solid white. This example represents the typical results of the conventional vertical printing method.

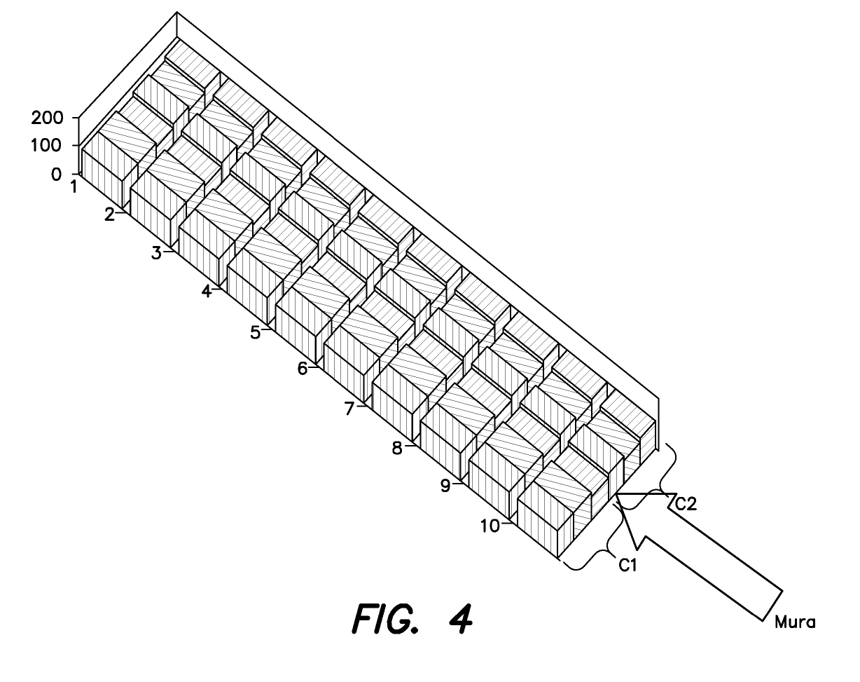

FIG. 4 is a perspective view representation of two columns of pixels C1, C2, with each pixel column C1, C2 including three sub-pixel columns. The height of each sub-pixel represents a total amount of ink that was deposited within the sub-pixel. Note that where the arrow indicates a mura irregularity, the adjacent columns of sub-pixels consistently have a relatively large variation in the amount of ink between the two sub-pixel columns. The effect results from a consistently reduced and/or increased amount of ink being deposited in a sub-pixel column next to a sub-pixel column with a nominal amount of ink. The problem can be aggravated by having a reduced ink sub-pixel column adjacent an increased ink sub-pixel column. Thus, either the consistently offset ink drops depicted in the example of FIG. 2 or the consistently reduced (or increased) ink quantities depicted in FIG. 4 may result in the visible mura effect shown in FIG. 3. Further, the combination of consistently offset drops and consistently reduced or increased amount of ink may create a cumulative visible mura irregularity even where only one of these situations might not have resulted in a visible mura effect.

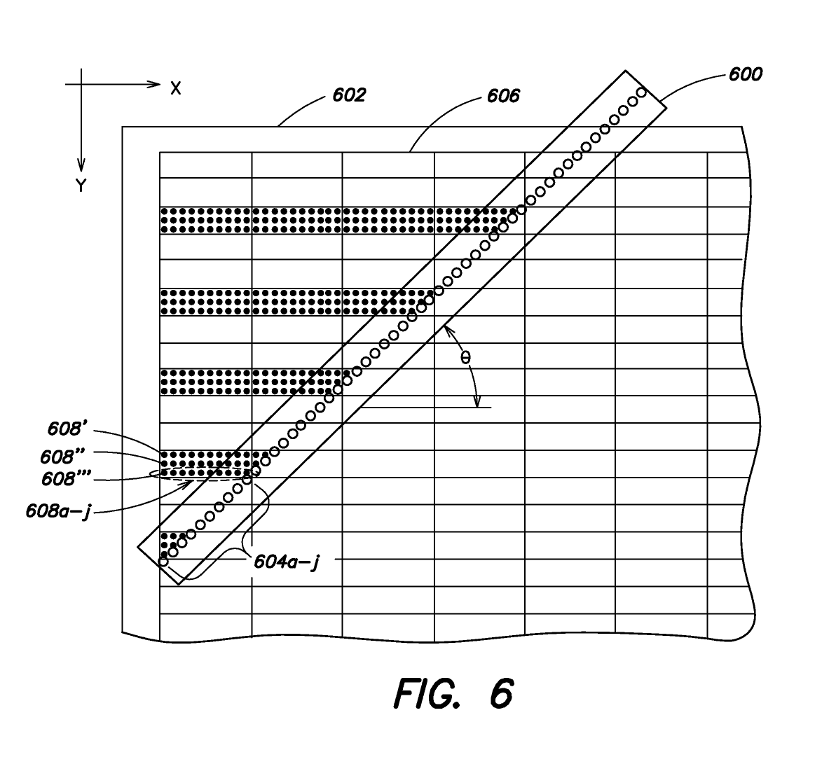

Perhaps somewhat counter intuitively, the present invention solves the problem of mura irregularities by effectively increasing the nominal error tolerances of the inkjet printer by using different nozzles and target drop sizes to fill any given sub-pixel well. This is done through the combination of horizontal and vertical printing method described in detail below with respect to FIG. 6. In other words, instead of attempting to reduce error tolerances below whatever thresholds at which the printer was designed to operate, the present invention varies the target drop size and/or drop position to prevent the repetition of the same small error in a column of drops that would otherwise become visible as a mura irregularity.

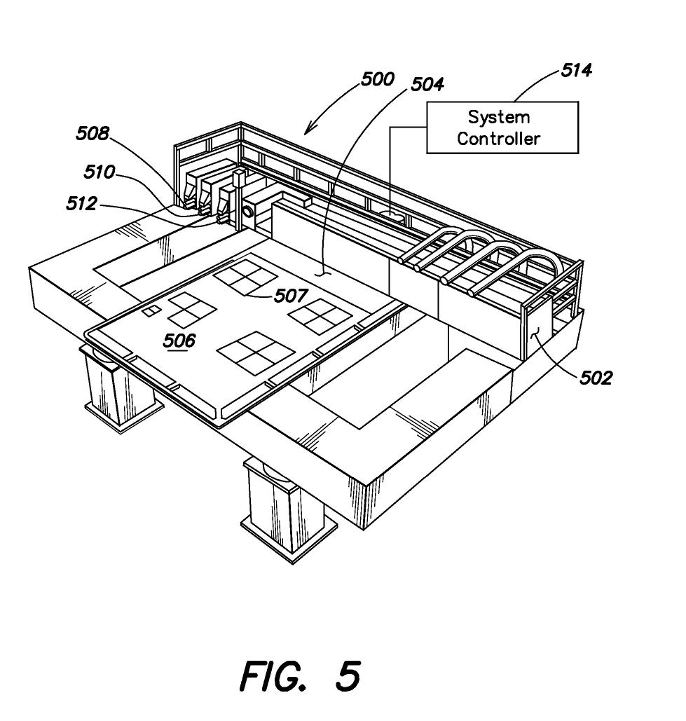

FIG. 5 illustrates a front perspective view of an embodiment of an inkjet printing system 500 of the present invention which is designated generally by reference numeral 500. The inkjet printing system 500 of the present invention, in an exemplary embodiment, may include a print bridge 502. The print bridge 502 may be positioned above and/or coupled to a stage 504. The stage 504 may support a substrate 506 which includes one or more display objects 507. Supported on print bridge 502, may be print heads 508, 510, 512. Print heads 508, 510, 512 and print bridge 502 may be coupled (e.g., logically and/or electrically) to and operate under the control of a system controller 514.

In the exemplary embodiment of FIG. 5, the print bridge 502 may be supported above the stage 504 in such a manner as to facilitate inkjet printing. The print bridge 502 and/or stage 504 may be movable each independently in both the positive and negative X- and Y-directions as indicated by the X- and Y-direction arrows in FIG. 5. In the same or alternative embodiments print bridge 502 and stage 504 may be rotatable so that the display objects 507 on the substrate 506 may be printed upon either laterally or longitudinally relative to the orientation of sub-pixel wells within the display objects 507. The print bridge 502 may be capable of supporting and moving any number of print heads 508, 510, 512 and/or other devices (e.g., sensors, imaging systems, range finders, etc.). The substrate 506 may sit atop or, in some embodiments, be coupled to the movable stage 504 (e.g., via a vacuum chuck).

Although only three print heads 508, 510, 512 are shown on print bridge 502 in FIG. 5, it is important to note that any number of print heads may be mounted on and/or used in connection with the print bridge 502 (e.g., 1, 2, 4, 5, 6, 7, etc. print heads). Likewise, although only one print bridge 502 is shown, any number of print bridges may be used (e.g., 2, 3, 4, 5, 6, 7, etc. print bridges). Print heads 508, 510, 512 may each be capable of dispensing a single color of ink or, in some embodiments, may be capable of dispensing multiple colors of ink. Inkjet print heads 508, 510, 512 may be independently movable and/or alignable vertically, horizontally and/or rotationally so as to enable accurate inkjet drop placement. The print bridge 502 may also be movable and/or rotatable to position print heads 508, 510, 512 for accurate inkjet printing. In operation, the inkjet print heads 508, 510, 512 may each dispense ink (e.g., from a plurality of nozzles) in drops under the control of the system controller 514.

An example of commercially available print heads suitable for use with the present invention are the model S-128 Series 128-Channel Jetting Assemblies manufactured by Spectra, Inc. of Lebanon, N.H. These particular jetting assemblies include two electrically independent piezoelectric slices, each with sixty-four addressable channels, which are combined to provide a total of 128 jets. The print head includes a nozzle plate having a number of nozzles which are arranged in a line, at approximately 0.020″ distance between nozzles. Other print heads with differently sized nozzles may also be used. The nozzles may comprise orifices in the nozzle plate or may comprise protrusions with openings that extend from the nozzle plate. In some embodiments, gold plated or gold coated print heads/nozzles may be used to help reduce wetting of the print heads/nozzles, particularly in conjunction with inkphobic surface treatments. Less wetting results in improved jetting performance by improving jetting reliability and drop size repeatability.

Turning to FIG. 6, a schematically represented example of a print head 600 in operation using a combined horizontal and vertical printing method is depicted. Although print head 600 is depicted as floating unsupported over a portion of substrate 602 in FIG. 6, this is merely a schematic representation and print head 600 may be supported by a gantry or print bridge 502 as depicted in FIG. 5. The print bridge 502 is omitted so as not to obstruct the view of the print head 600. Likewise, print head 600 is schematically depicted as transparent so that the nozzles 604 (only 604a-j are labeled) of the print head 600, display object sub-pixel wells 606 (only one labeled), and deposited ink drops 608 (only 608a-j are labeled) on the substrate 602 may be more clearly seen.

In operation, the substrate 602 is oriented such that the longitudinal axis of the sub-pixel wells 606 (of the display objects) are substantially perpendicular to the printing direction Y as indicated by the Y axis. In other words, printing is performed across the narrow dimension of the sub-pixel wells 606. (Note that printing may be performed in both the positive and negative Y directions.) The print head 600 is angled at a saber angle θ relative to the X direction so that the effective pitch (e.g. the distance between the nozzles 604 projected on to the X-axis) of the print head 600 is set to allow a desired number of nozzles 604 to pass over each sub-pixel well 606.

In the example of FIG. 6, the saber angle θ is set such that ten nozzles 604a-j pass over each sub-pixel well 606 as the substrate 602 is moved below the print head 600. According to the present invention, as each of the ten nozzles 604a-j pass over the sub-pixel wells 606, each nozzle 604a-j in turn deposits two or more ink drops 608a-j within each sub-pixel well 606.

In the particular example of FIG. 6, each nozzle 604a-j has deposited three ink drops 608a-j such that three rows 608′, 608″, 608′″ of ink drops 608a-j are deposited within each sub-pixel well 606. Although three rows are depicted in the example, any number of rows may be deposited up to the maximum number of drops that can be deposited in a sub-pixel well in the print direction (e.g., in this case the narrow dimension of the sub-pixel well). The maximum number of drops that can be deposited over a given distance may be determined based on the maximum jetting frequency and the maximum speed of the stage at which drops can still be accurately placed.

Further, the size of the ink drops may be controlled by adjusting the fire pulse voltage used to activate the individual inkjets to eject an ink drop as described in previously incorporated U.S. patent application Ser. No. 11/061,120, filed Feb. 18, 2005 and entitled “Methods And Apparatus For Precision Control Of Print Head Assemblies.” By setting the fire pulse voltage low enough, a nozzle can be prevented from ejecting a drop at all. Thus, any desired amount of ink may be deposited in a sub-pixel well independent of the number of rows 608′, 608″, 608′″ of ink drops 608a-j that are deposited. Therefore, by using differently sized drops for the different rows of ink drops, additional variation may be introduced to further reduce the likelihood of mura irregularities.

Note that in the example depicted in FIG. 6, the print head 600 only deposits ink in every third row of sub-pixel wells 606. The skipped rows may be filled by different print heads (not shown) either in subsequent print passes, or, in some embodiments, in the same print pass by other print heads (not shown) that trail behind the depicted print head 600.

As indicated above and in contrast to the combination horizontal and vertical printing method of the present invention, vertical printing refers to the conventional method of printing in which (1) the print direction is substantially parallel to the longitudinal dimension of the sub-pixel wells and (2) the print head is disposed so that only one nozzle on the print head may deposit multiple drops of ink in a given sub-pixel well. Thus, any given column of sub-pixel wells are filled by a single nozzle. As indicated above, this method of printing may result in mura irregularities.

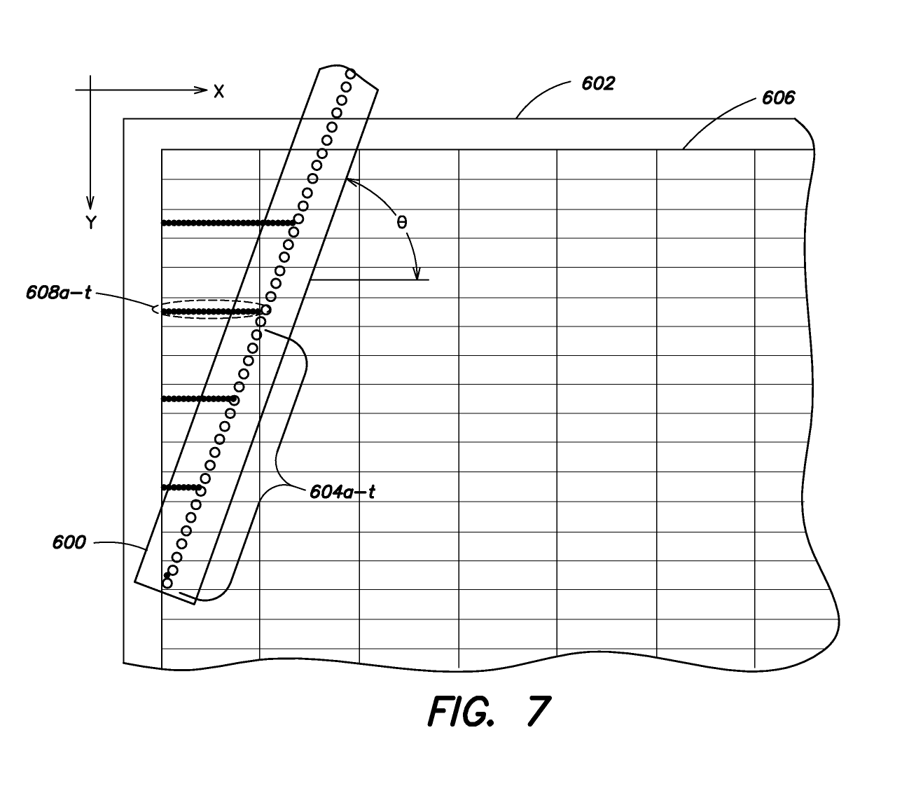

Turning to FIG. 7, a schematically represented example of a print head 600 in operation using a horizontal printing method is depicted. As indicated above, horizontal printing refers to a method of printing color filters in which (1) the print direction Y is substantially perpendicular to the longitudinal dimension (e.g., the longest length) of the sub-pixel wells 606 and (2) the print head 600 is disposed so that each nozzle 604 on the print head 600 may deposit a single drop of ink 608 within each sub-pixel well 606 over which the nozzle 604 passes but multiple nozzles 604 pass over each sub-pixel well 606. Thus, for example as depicted in FIG. 7, if the saber angle θ of the print head 600 is such that twenty nozzles 604a-t pass over each sub-pixel well 606, then twenty drops 608a-t may be deposited within the sub-pixel well 606 (assuming each nozzle 604a-t is fired while passing over the sub-pixel well 606). The relationship between the number “n” of nozzles required to fill one sub-pixel and the saber angle θ may be expressed by the equation:

$$COS ( Θ ) = \frac{P}{n ⨯ ρ}$$

where η represents saber angle, P represents the longitudinal dimension of the sub-pixel well, n represents the number of nozzles required to fill the sub-pixel, and ρ represents the nozzle pitch (e.g., the actual distance between nozzles). This equation may also be used to determine the number “N” of nozzles required to span a sub-pixel well given a particular saber angle θ in a combination horizontal and vertical printing method context by replacing n with N in the equation.

While the horizontal method of printing reduces the likelihood that a mura irregularity will occur (e.g., because a number of different nozzles 604a-t are used to fill each sub-pixel well 606), the saber angle θ required to align an adequate number of nozzles 604 with each sub-pixel well 606 sufficient to fill the sub-pixel well 606 (using only one ink drop 608 per nozzle 604) results in a significant impact on print performance since the number of print passes is significantly increased compared to both the conventional vertical printing method and the combination horizontal and vertical printing method of the present invention. The combination horizontal and vertical printing method allows more sub-pixels to be filled per print pass than both vertical printing and horizontal printing. In addition, by selecting a print head with more nozzles (e.g., multiple rows of nozzles), the combination horizontal and vertical printing method enables higher throughput. In contrast, vertical printing and horizontal printing do not benefit from an increased number of nozzles.

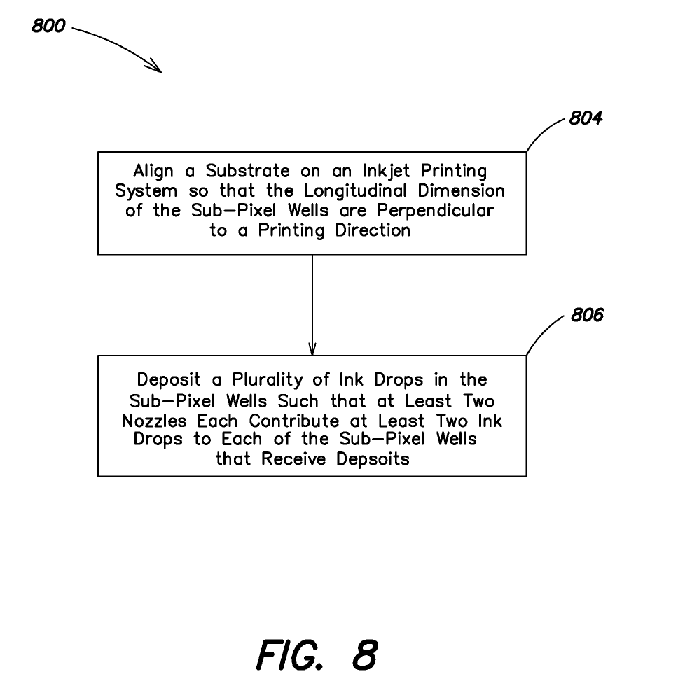

Turing to FIG. 8, a flowchart is provided that depicts an example the combination horizontal and vertical printing method 800 of the present invention. In step 802, the method begins. In step 804, a substrate is aligned on an inkjet printing system so that a longitudinal dimension of at least one sub-pixel well on the substrate is substantially perpendicular to a printing direction of the inkjet printing system. In Step 806, a plurality of ink drops are deposited in the sub-pixel. At least two nozzles of the print head each deposit at least two ink drops in the sub-pixel well. The method 800 ends at step 808.

In another aspect, the printing method of the present invention allows a inkjet printing system to compensate for one or more failed or failing nozzles on a print head. If it is determined that a nozzle is not jetting ink properly, use of the nozzle may be terminated and adjacent nozzles may be adapted to deposit larger drops to compensate for the deactivated nozzle. In the case of a nozzle failure at either end of a group of nozzles filling a column of pixel wells, unused nozzles may be employed to replace the failed nozzle by shifting the nozzles laterally.

The foregoing description discloses only particular embodiments of the invention; modifications of the above disclosed methods and apparatus which fall within the scope of the invention will be readily apparent to those of ordinary skill in the art. For instance, it will be understood that the invention also may be employed with any type of ink or color filter material to make any type or size color filter.

In some embodiments, the printing methods of the present invention may be used with an inkjet printing system such as disclosed in previously incorporated U.S. Provisional Patent Application Ser. No. 60/625,550, filed Nov. 4, 2004 and entitled “APPARATUS AND METHODS FOR FORMING COLOR FILTERS IN A FLAT PANEL DISPLAY BY USING INKJETTING.” Further, the present invention may also be applied to processes for spacer formation, polarizer coating, and nanoparticle circuit forming.

Accordingly, while the present invention has been disclosed in connection with specific embodiments thereof, it should be understood that other embodiments may fall within the spirit and scope of the invention, as defined by the following claims.

The invention claimed is:

1. A method comprising:
aligning a substrate on an inkjet printing system so that a longitudinal dimension of at least one sub-pixel well on the substrate is substantially perpendicular to a printing direction of the inkjet printing system; and
depositing a plurality of ink drops in the sub-pixel well using a print head having a plurality of nozzles wherein at least two of the nozzles each deposit at least two ink drops in the sub-pixel well.

2. The method of claim 1 further comprising aligning the print head at an angle relative to the print direction so that a potential number of drops to be deposited in the sub-pixel well equals an integer multiple of a number of nozzles that will pass over the sub-pixel well.

3. The method of claim 1 further comprising depositing additional pluralities of ink drops in other sub-pixel wells on the substrate wherein the sub-pixel wells are arranged in multiple rows and the depositing additional pluralities of ink drops is into every third row of sub-pixel wells.

4. The method of claim 1 wherein a number of nozzles required to span the sub-pixel may be determined by solving an equation for N where the equation is expressed as:
$$COS ( Θ ) = \frac{P}{N ⨯ ρ}$$
where θ represents a saber angle, P represents a longitudinal dimension of the sub-pixel well, n represents the number of nozzles required to span the sub-pixel, and ρ represents a nozzle pitch.

5. The method of claim 1 further comprising moving the substrate in the printing direction while depositing the plurality of ink drops, and
wherein the nozzles deposit ink drops in turn as the pixel well passes under the nozzles.

6. The method of claim 1 further comprising varying a size of the ink drops deposited by a given nozzle.

7. A method comprising:
aligning a substrate so that a longitudinal dimension of a plurality of sub-pixel wells formed on the substrate are substantially perpendicular to a printing direction; and
depositing ink in a subset of the sub-pixel wells via nozzles of a print head wherein each of a plurality of the nozzles deposits a plurality of ink drops in each of the subset of the sub-pixel wells.

8. An apparatus comprising:
a stage adapted to align a substrate; and
a print head including a plurality of nozzles and being adapted to deposit ink drops into pixel wells on the substrate,
wherein the apparatus is operative to:
align the substrate on the stage so that a longitudinal dimension of a plurality of sub-pixel wells formed on the substrate are substantially perpendicular to a printing direction; and
deposit ink in a subset of the sub-pixel wells via the nozzles wherein each of the nozzles deposits a plurality of ink drops in each of the subset of the sub-pixel wells.

9. The apparatus of claim 8 wherein the apparatus is further operative to align the print head at an angle relative to the print direction so that a potential number of drops to be deposited in each sub-pixel well equals an integer multiple of a number of nozzles that will pass over each sub-pixel well.

10. The apparatus of claim 8 wherein the apparatus is further operative to deposit additional pluralities of ink drops in other sub-pixel wells on the substrate wherein the sub-pixel wells are arranged in multiple rows and the depositing additional pluralities of ink drops is into every third row of sub-pixel wells.

11. The apparatus of claim 8 wherein a number of nozzles required to span a sub-pixel may be determined by solving an equation for N where the equation is expressed as:
$$COS ( Θ ) = \frac{P}{N ⨯ ρ}$$
where θ represents a saber angle, P represents a longitudinal dimension of the sub-pixel well, N represents the number of nozzles required to span the sub-pixel, and ρ represents a nozzle pitch.

12. The apparatus of claim 8 wherein the apparatus is further operative to move the substrate in the printing direction while depositing the plurality of ink drops, and
wherein the nozzles deposit ink drops in turn as the pixel well passes under the nozzles.

13. The apparatus of claim 8 wherein the apparatus is further operative to vary a size of the ink drops deposited by a given nozzle.

14. A system for inkjet printing comprising:
a stage adapted to align a substrate;
a print bridge spanning across the stage;
a plurality of print heads supported by the print bridge, each print head including a plurality of nozzles and being adapted to deposit ink drops into pixel wells on the substrate,
wherein the system is operative to:
align the substrate on the stage so that a longitudinal dimension of a plurality of sub-pixel wells formed on the substrate are substantially perpendicular to a printing direction; and
deposit ink in a subset of the sub-pixel wells via the nozzles wherein each of the nozzles deposits a plurality of ink drops in each of the subset of the sub-pixel wells.

15. The system of claim 14 wherein the system is further operative to align the print head at an angle relative to the print direction so that a potential number of drops to be deposited in each sub-pixel well equals an integer multiple of a number of nozzles that will pass over each sub-pixel well.

16. The system of claim 14 wherein the system is further operative to deposit additional pluralities of ink drops in other sub-pixel wells on the substrate wherein the sub-pixel wells are arranged in multiple rows and the depositing additional pluralities of ink drops is into every third row of sub-pixel wells.

17. The system of claim 14 wherein a number of nozzles required to span a sub-pixel may be determined by solving an equation for N where the equation is expressed as:
$$COS ( Θ ) = \frac{P}{N ⨯ ρ}$$
where θ represents a saber angle, P represents a longitudinal dimension of the sub-pixel well, N represents the number of nozzles required to span the sub-pixel, and ρ represents a nozzle pitch.

18. The system of claim 14 wherein the system is further operative to move the substrate in the printing direction while depositing the plurality of ink drops, and
wherein the nozzles deposit ink drops in turn as the pixel well passes under the nozzles.

19. The system of claim 14 wherein the system is further operative to vary a size of the ink drops deposited by a given nozzle.

20. The system of claim 14 wherein a mura irregularity is avoided by printing more than one drop in each sub-pixel well using different inkjet nozzles.
